(19) United States
(12) Patent Application Publication
(10) Pub. No.: US 2012/0297809 A1
(43) Pub. Date: Nov. 29, 2012

(54) REFRIGERANT LOOP FOR BATTERY ELECTRIC VEHICLE WITH INTERNAL HEAT EXCHANGER FOR HEAT EXCHANGE WITH COOLANT

(76) Inventor: Neil Carpenter, Clarkston, MI (US)

(21) Appl. No.: 13/481,702

(22) Filed: May 25, 2012

Related U.S. Application Data
(60) Provisional application No. 61/490,161, filed on May 26, 2011.

(51) Int. Cl. B60H 1/32; B60H 1/00

(52) U.S. Cl. 62/244; 62/239

(57) ABSTRACT

In an aspect, a thermal management system for an electric vehicle is provided. The thermal management system includes a battery circuit that transports coolant for cooling a thermal load that includes at least one traction battery, a refrigerant circuit that includes a compressor, a condenser and an evaporator. The thermal management system further includes an internal heat exchanger through which both refrigerant and coolant flow so as to cool the coolant in the battery circuit. Optionally, the thermal management system may further include a chiller. In this optional case the internal heat exchanger may be used to pre-cool the coolant upstream from the chiller. Alternatively the internal heat exchanger may be used to cool the coolant so as to delay initiating operation of the chiller.

### CROSS-REFERENCE TO RELATED APPLICATIONS

This application claims the benefit of U.S. Provisional Patent Application No. 61/490,161, filed May 26, 2011, the disclosure of which is incorporated fully herein by reference.

### FIELD

Example embodiment relates to electric vehicles (i.e. vehicles that are powered at least partly by an electric motor) and more particularly to battery electric vehicles with no internal combustion engine on board.

### BACKGROUND

Electric vehicles offer the promise of powered transportation through the use of electric motors while producing few or no emissions. Some electric vehicles are powered by electric motors only and rely solely on the energy stored in an on-board battery pack. Other electric vehicles are hybrids, and include an internal combustion engine, which may, for example, be used to assist the electric motor in driving the wheels (a parallel hybrid), or which may, for example, be used solely to charge the on-board battery pack, thereby extending the operating range of the vehicle (a series hybrid). In some vehicles, there is a single, centrally-positioned electric motor that powers one or more of the vehicle wheels, and in other vehicles, one or more of the wheels have an electric motor positioned at each driven wheel.

While currently proposed and existing vehicles are advantageous in some respects over internal-combustion engine powered vehicles, there are problems that are associated with some electric vehicles. One problem is that their range is typically relatively short as compared to internal combustion engine-powered vehicles. This is particularly true for battery electric vehicles that are not equipped with range extender engines. Systems or devices that can reduce the energy consumption of these vehicles is beneficial. Furthermore, such vehicles would benefit from a simplification of their various systems, so as to reduce the component count and therefore reduce the likelihood of a component failure, and so as to reduce cost.

### SUMMARY

In an aspect, a thermal management system for an electric vehicle is provided. The thermal management system includes a battery circuit that transports coolant for cooling a thermal load that includes at least one traction battery, a refrigerant circuit that includes a compressor, a condenser and an evaporator. The thermal management system further includes an internal heat exchanger through which both refrigerant and coolant flow so as to cool the coolant in the battery circuit. Optionally, the thermal management system may further include a chiller. In this optional case the internal heat exchanger may be used to pre-cool the coolant upstream from the chiller. Alternatively the internal heat exchanger may be used to cool the coolant so as to delay initiating operation of the chiller.

In a particular example, the electric vehicle may include a traction motor and at least one battery pack. The thermal management system includes a radiator, a battery circuit, a refrigerant circuit and an internal heat exchanger. The battery circuit controls the temperature of a battery circuit thermal load which includes the at least one battery pack. The battery circuit thermal load has a battery circuit thermal load inlet and a battery circuit thermal load outlet. The battery circuit includes a plurality of battery circuit conduits fluidically between the radiator and the battery circuit thermal load. The refrigerant circuit includes an evaporator thermal expansion valve, an evaporator downstream from the evaporator thermal expansion valve, a condenser upstream from the evaporator, a compressor that is downstream from the evaporator and upstream from the condenser, and a plurality of refrigerant conduits fluidically connecting the evaporator, the condenser and the compressor together. The internal heat exchanger comprises an inner conduit and an outer conduit. The inner conduit extends within the outer conduit. One of the inner and outer conduits is fluidically connected as part of the battery circuit. The other of the inner and outer conduits is fluidically connected as part of the refrigerant circuit.

### BRIEF DESCRIPTION OF THE DRAWINGS

Embodiments will now be described, by way of example only, with reference to the attached drawings, in which:

FIG. 1 is a side view of an example embodiment of an electric vehicle that includes a thermal management system;

FIG. 2 is a schematic illustration of the thermal management system for the electric vehicle shown in FIG. 1;

FIG. 3 is a magnified view of an internal heat exchanger that is part of the thermal management system for the vehicle shown in FIG. 1; and

FIG. 4 is a schematic illustration of an alternative thermal management system for the electric vehicle shown in FIG. 1;

FIG. 5 is a schematic illustration of another alternative thermal management system for the electric vehicle shown in FIG. 1, which includes a chiller; and

FIG. 6 is a schematic illustration of yet another alternative thermal management system for the electric vehicle shown in FIG. 1, which includes a chiller.

### DETAILED DESCRIPTION

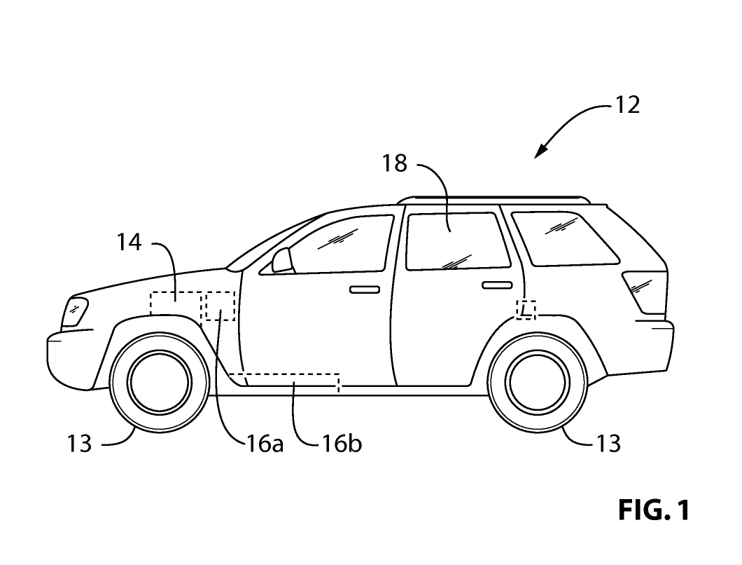

Reference is made to FIG. 1, which shows an electric vehicle 10 which has a thermal management system 12. The electric vehicle 10 includes wheels 13, a traction motor 14 for driving the wheels 13, first and second battery packs 16a and 16b, a cabin 18.

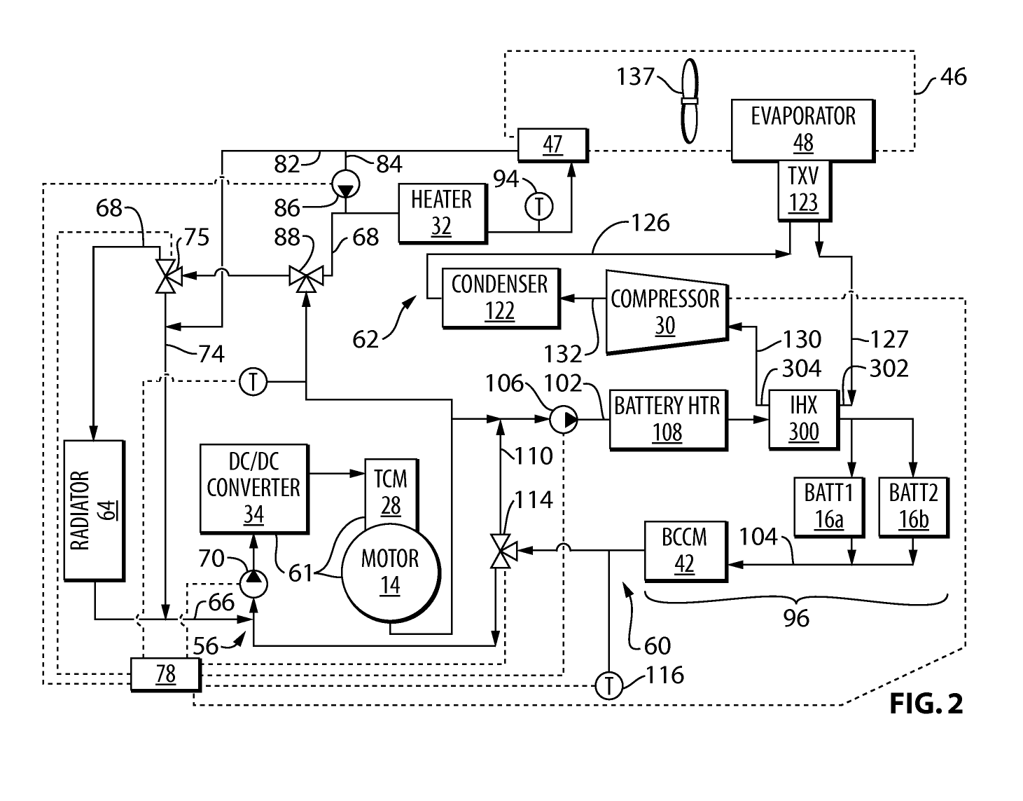

The motor 14 may have any suitable configuration for use in powering the electric vehicle 12. The motor 14 may be mounted in a motor compartment that is forward of the cabin 18 and that is generally in the same place an engine compartment is on a typical internal combustion powered vehicle. Referring to FIG. 2, the motor 14 generates heat during use and thus requires cooling. To this end, the motor 14 includes a motor coolant flow conduit for transporting coolant about the motor 14 so as to maintain the motor within a suitable temperature range.

A transmission control system shown at 28 is part of the vehicle's high voltage electrical system and is provided for controlling the current flow to high voltage electrical loads within the vehicle 12, such as the motor 14, an air conditioning compressor 30, a heater 32 and a DC/DC converter 34. The transmission control system 28 generates heat during use. There is a transmission control system coolant flow conduit associated with the transmission control system 28, for transporting coolant about the transmission control system 28 so as to maintain the transmission control system 28 within a suitable temperature range. The transmission control system 28 may be positioned immediately upstream fluidically from the motor 14.

The DC/DC converter 34 receives current from the transmission control system 28 and converts the current from high voltage to low voltage. The DC/DC converter 34 sends the low voltage current to a low voltage battery (not shown), which is used to power low voltage loads in the vehicle 12.

The battery packs 16a and 16b send power to the transmission control system 28 for use by the motor 14 and other high voltage loads and thus form part of the high voltage electrical system. The battery packs 16a and 16b may be any suitable types of battery packs. In an embodiment, the battery packs 16a and 16b are each made up of a plurality of lithium polymer cells. The battery packs 16a and 16b have a temperature range in which they may be maintained so as to provide them with a relatively long operating life. While two battery packs 16a and 16b are shown, it is alternatively possible to have any suitable number of battery packs, such as one battery pack, or three or more battery packs depending on the packaging constraints of the vehicle 12.

A battery charge control module shown at 42 is provided and is configured to connect the vehicle 12 to an electrical source (e.g. a 110V source, or a 220V source—not shown), and to send the current received from the electrical source to any of several destinations, such as, the battery packs 16a and 16b, the transmission control system 28 and the low voltage battery. The battery charge control module 42 generates heat during use and thus requires cooling. To this end, the battery charge control module 42 includes a battery charge control module fluid flow conduit for transporting fluid about the battery charge control module 42 so as to maintain the battery charge control module 42 within a suitable temperature range.

An HVAC system 46 is provided for controlling the temperature of the cabin 18 (FIG. 1). The HVAC system 46 is configured to be capable of both cooling and heating the cabin 18. To achieve this, the HVAC system 46 may include one or more heat exchangers, such as a cabin heating heat exchanger 47 and a cabin cooling heat exchanger 48 (which is an evaporator in a refrigerant circuit shown at 62). The cabin cooling heat exchanger 48 is used to cool an air flow that is passed into the cabin 18.

The motor 14, the transmission control system 28, the DC/DC converter 34, the battery packs 16a and 16b, the battery charge control module 42 and the HVAC system 46 constitute thermal loads on the thermal management system 10.

The thermal management system 10 includes a motor circuit 56, a cabin heating circuit 58, a battery circuit 60 and a refrigerant circuit 62. The motor circuit 56 is configured for cooling the traction motor 14, the transmission control system 28 and the DC/DC converter 34, which constitute a motor circuit thermal load 61. The motor circuit 56 includes a radiator 64, a first motor circuit conduit 66 fluidically between the radiator 64 and the motor circuit thermal load inlet, a second motor circuit conduit 68 fluidically between the motor circuit thermal load outlet and the radiator 64, and a motor circuit pump 70 positioned to pump heat exchange fluid (i.e. coolant) through the motor circuit 56.

Additionally a third motor circuit conduit 74 may be provided fluidically between the second and first motor circuit conduits 68 and 66 so as to permit the flow of heat exchange fluid to bypass the radiator 64 when possible (e.g. when the heat exchange fluid is below a selected threshold temperature). To control whether the flow of heat exchange fluid is directed through the radiator 64 or through the third motor circuit conduit 74, a radiator bypass valve 75 is provided and may be positioned in the second motor circuit conduit 68. The radiator bypass valve 75 is controllable so that in a first position the radiator bypass valve 75 directs the flow of heat exchange fluid to the radiator 64 through the second motor circuit conduit 68 and in a second position the radiator bypass valve 75 directs the flow of heat exchange fluid to the first motor circuit conduit 66 through the third motor circuit conduit 74, so as to bypass the radiator 64. Flow through the third motor circuit conduit 74 is easier than flow through the radiator 64 (i.e. there is less of a pressure drop associated with flow through the third conduit than there is with flow through the radiator 64) and so bypassing the radiator 64 whenever possible, reduces the energy consumption of the pump 70. By reducing the energy consumed by components in the vehicle 12 (FIG. 1), the range of the vehicle can be extended, which is particularly advantageous in electric vehicles.

It will be noted that only a single radiator bypass valve 75 is provided for bypassing the radiator 64. When the radiator bypass valve 75 is in the first position, all of the heat exchange fluid flow is directed through the second conduit 68, through the radiator 64 and through the first conduit 66. There is no net flow through the third conduit 74 because there is no net flow into the third conduit. Conversely, when the radiator bypass valve 75 is in the second position, all of the heat exchange fluid flow is directed through the third conduit 74 and back to the first conduit 66. There is no net flow through the radiator 64 because there is no net flow into the radiator 64. Thus, using only a single valve (i.e. the bypass valve 75) provides the capability of selectably bypassing the radiator 64, instead of using one valve at the junction of the second and third conduits 68 and 74 and another valve at the junction of the first and third conduits 66 and 74. As a result of using one valve (i.e. valve 75) instead of two valves, the motor circuit 56 contains fewer components, thereby making it less expensive, simpler to make and to operate and more reliable. Furthermore by eliminating one valve, the energy required to move the heat exchange fluid through the motor circuit 56 is reduced, thereby reducing the energy consumed by the pump 70 and extending the range of the vehicle 12 (FIG. 1).

The pump 70 may be positioned anywhere suitable, such as in the first motor circuit conduit 66.

The elements that make up the motor circuit thermal load may be arranged in any suitable way. For example, the DC/DC converter 34 may be downstream from the pump 70 and upstream from the transmission control system 28, and the motor 14 may be downstream from the transmission control system 28. Thus, the inlet to the DC/DC converter 34 constitutes the thermal load inlet and the motor outlet constitutes the thermal load outlet.

A motor circuit temperature sensor 76 is provided for determining the temperature of heat exchange fluid at a selected point in the motor circuit 56. As an example, the motor circuit temperature sensor 76 may be positioned downstream from all the thermal loads in the motor circuit 56, so as to record the highest temperature of the heat exchange fluid. Based on this temperature, a controller, shown at 78 can determine whether or not to position the radiator bypass valve 75 in a first position wherein the radiator bypass valve 75 transfers the flow of heat exchange fluid towards the radiator 64 and a second position wherein the radiator bypass valve 75 bypasses the radiator 64 and transfers the flow of heat exchange fluid through the third motor circuit conduit 74 back to the first motor circuit conduit 66.

The cabin heating circuit 58 is configured for providing heated heat exchange fluid to the HVAC system 46 and more specifically to the cabin heating heat exchanger 47, which constitutes the cabin heating circuit thermal load. The cabin heating circuit 58 includes a first cabin heating circuit conduit 80 fluidically between the second motor circuit conduit 68 and the cabin heating heat exchanger inlet (which in the embodiment shown is the inlet to the cabin heating circuit thermal load), a second cabin heating circuit conduit 82 fluidically between the cabin heating circuit heat exchanger outlet (which in the embodiment shown is the outlet from the cabin heating circuit thermal load) to the motor circuit 56. In the embodiment shown the second cabin heating circuit conduit 82 extends to the third motor circuit conduit 74. This is because the cabin heating heat exchanger 47 serves to cool the heat exchange fluid by some amount, so that the resulting cooled heat exchange fluid need not be passed through the radiator 64 in the motor circuit 56. By reducing the volume of heat exchange fluid that passes through the radiator 64, energy consumed by the pump 70 is reduced, thereby extending the range of the vehicle 12 (FIG. 1). It will be understood that in an alternative embodiment however, the second cabin heating circuit conduit 82 may extend to the second motor circuit conduit 68 downstream so that the heat exchange fluid contained in the second cabin heating circuit conduit 82 passes through the radiator 64.

In some situations the heat exchange fluid will not be sufficiently hot to meet the demands of the HVAC system 46. For such situations, the heater 32 which may be referred to as the cabin heating circuit heater 32 is provided in the first cabin heating circuit conduit 80. The cabin heating circuit heater 32 may be any suitable type of heater, such as an electric heater that is one of the high voltage electrical components fed by the transmission control system 28.

A third cabin heating circuit conduit 84 may be provided between the second and first cabin heating circuit conduits 82 and 80. A cabin heating circuit pump 86 is provided in the third conduit 84. In some situations it will be desirable to circulate heat exchange fluid through the cabin heating circuit 58 and not to transfer the fluid back to the motor circuit 56. For example, when the fluid is being heated by the heater 32 it may be advantageous to not transfer the fluid back to the motor circuit 56 since the fluid in the motor circuit 56 is used solely for cooling the thermal load 61 and it is thus undesirable to introduce hot fluid into such a circuit. For the purpose of preventing fluid from being transferred from the cabin heating circuit 58 back to the motor circuit 56, a cabin heating circuit valve 88 is provided. In the embodiment shown, the cabin heating circuit valve 88 is positioned in the second motor circuit conduit 68 and is positionable in a first position wherein the valve 88 directs fluid flow towards the radiator 64 through the second motor circuit conduit 68, and a second position wherein the valve 88 directs fluid flow towards the cabin heater heat exchanger 47 through the first cabin heating circuit conduit 80.

When the cabin heating circuit valve 88 is in the second position, the pump 86 may operate at a selected, low, flow rate to prevent the fluid flow from short circuiting the cabin heating circuit by flowing up the third conduit 84.

When the valve 88 is positioned in the first position, fluid is directed towards the radiator 64. There is no net flow out of the cabin heating circuit 58 since there is no flow into the cabin heating circuit 58. When the valve 88 is positioned in the second position and the pump 86 is off, fluid is directed through the cabin heating circuit 58 and back into the motor circuit 56. When the valve 88 is positioned in the first position and the pump 86 is on, there is no net flow out of the second cabin heating circuit conduit 82 as noted above, however, the pump 86 generates a fluid circuit loop and drives fluid in a downstream portion of the first cabin heating circuit conduit 80, through the cabin heating heat exchanger 47, and through an upstream portion of the second cabin heating circuit conduit 82, whereupon the fluid is drawn back into the pump 86. Additionally, the valve 88 combined with the pump 86 permit isolating heated fluid in the cabin heating circuit 58 from the fluid in the motor circuit 56, thereby preventing fluid that has been heated in the cabin heating circuit heater 32 from being sent to the radiator 64 to be cooled.

A cabin heating circuit temperature sensor 94 may be provided for determining the temperature of the fluid in the cabin heating circuit 58. The temperature sensor 94 may be positioned anywhere suitable, such as downstream from the cabin heating circuit heater 32. The temperature sensor 94 may communicate with the controller 78 so that the controller 78 can determine whether or not to carry out certain actions. For example, using the temperature sensed by the temperature sensor 94, the controller 78 can determine whether the heater 32 should be activated to meet the cabin heating demands of the HVAC system 46.

The battery circuit 60 is configured for controlling the temperature of the battery packs 16a and 16b and the battery charge control module 42, which together make up the battery circuit thermal load 96. A thermal load inlet is shown at 98 upstream from the battery packs 16a and 16b and a thermal load outlet is shown at 100 downstream from the battery charge control module 42. The battery packs 16a and 16b are in parallel in the battery circuit 60, which permits the fluid flow to each of the battery packs 16a and 16b to be selected individually so that each battery pack 16a or 16b receives as much fluid as necessary to achieve a selected temperature change. It may be possible to provide a means for adjusting the flow of fluid that goes to each battery pack 16a and 16b during use of the thermal management system 10, so that the fluid flow can be adjusted to meet the instantaneous demands of the battery packs 16a and 16b. After the fluid has passed through the battery packs 16a and 16b, the fluid is brought into a single conduit which passes through the battery charge control module 42. While the battery packs 16a and 16b are shown in parallel in the battery circuit 60, they could be provided in series in an alternative embodiment.

A first battery circuit conduit 102 extends between the second motor circuit conduit 68 and the battery circuit thermal load inlet. A second battery circuit conduit 104 extends between the thermal load outlet and the first motor circuit conduit 66. A battery circuit pump 106 may be provided for pumping fluid through the battery circuit 60 in situations where the battery circuit 60 is isolated from the motor circuit 56. A battery circuit heater 108 is provided in the first conduit 102 for heating fluid upstream from the thermal load 96 in situations where the thermal load 96 requires such heating.

A third battery circuit conduit 110 may be provided fluidically between the second and first battery circuit conduits 102 and 104 so as to permit the flow of heat exchange fluid in the battery circuit 60 to be isolated from the flow of heat exchange fluid in the motor circuit 56.

A battery circuit valve 114 is provided in the second conduit 104 and is positionable in a first position wherein the flow of fluid is directed towards the first motor circuit conduit 66 and in a second position wherein the flow of fluid is directed into the third battery circuit conduit 114 towards the first battery circuit conduit 102.

When the valve 114 is in the second position so as to direct fluid flow through the third conduit 110 into the first conduit 102, there is effectively no flow from the first motor circuit 56 through the first conduit 102 since the loop made up of the downstream portion of the first conduit 102, the thermal load 96, the second conduit 104 and the third conduit 110 is already full of fluid.

A battery circuit temperature sensor 116 is provided for sensing the temperature of the fluid in the battery circuit 60. The temperature sensor 116 may be positioned anywhere in the battery circuit 60, such as in the second conduit 104 downstream from the thermal load 96. The temperature from the temperature sensor 116 can be sent to the controller 78 to determine whether to have the valve 114 should be in the first or second position and whether any devices need to be operated to adjust the temperature of the fluid in the first conduit 102.

The refrigerant circuit 62 is provided for assisting in the thermal management of the thermal load in the HVAC system 46 (i.e. evaporator 48) and the thermal load in the battery circuit 60 (i.e. the first and second battery packs 16a and 16b and the battery charge control module 42).

Primary components of the refrigerant circuit 62 include the compressor 30, a condenser 122, the evaporator 48, an evaporator thermal expansion valve 123 and an internal heat exchanger 300. The compressor 30 may be a variable speed device that is driven by an electric motor. A first refrigerant conduit 126, which is referred to as a liquid conduit 126 extends between the condenser 122 and the evaporator 48. A second refrigerant conduit 127 which is referred to as an internal heat exchanger inlet conduit 127 extends from the evaporator 48 to a refrigerant inlet 302 of the internal heat exchanger 300. A third refrigerant conduit 130 which is referred to as a compressor suction conduit 130 extends from a refrigerant outlet 304 of the internal heat exchanger 300 to the compressor 30. A fourth refrigerant conduit 132 which is referred to as a compressor discharge conduit 132 extends from the compressor 30 to the condenser 122.

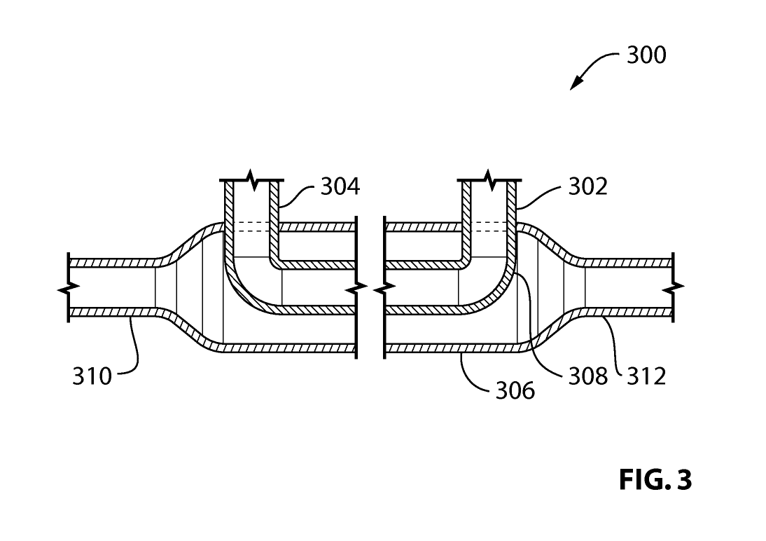

Referring to FIG. 3, the internal heat exchanger 300 is made up of an outer conduit 306 and an inner conduit 308 that extends within the outer conduit 306. The routing of the inner conduit 308 may be any suitable routing to provide a suitable heat exchange between the fluids contained in the two conduits 306 and 308. The inner conduit 308 may, for example, have a helical routing, or alternatively a straight routing. In the embodiment shown the outer conduit 306 transports coolant from the battery circuit 60 (and may thus constitute a coolant conduit), and the inner conduit 308 transports refrigerant from the refrigerant circuit 62 (and may thus constitute a refrigerant conduit). The refrigerant conduit 308 extends between the refrigerant inlet 302 and the refrigerant outlet 304. The coolant conduit 306 extends between a coolant inlet 310 and a coolant outlet 312. The internal heat exchanger 300 is positioned in the first battery circuit conduit 102 and is used to cool coolant in the battery circuit 60 upstream from the battery circuit thermal load 96 to assist in cooling the battery circuit thermal load 96 when desired.

It is alternatively possible however, for the inner conduit 306 to transport coolant from the battery circuit 60 (FIG. 2), and for the outer conduit 308 to transport refrigerant from the refrigerant circuit 62.

The internal heat exchanger 300 may be a counterflow configuration, wherein the coolant and refrigerant flow in opposite directions from each other, as shown in FIG. 2. Alternatively, the flows of the coolant and refrigerant may be in the same direction.

The internal heat exchanger 300 is a relatively simple and inexpensive pipe-within-a-pipe heat exchanger that has been proposed for use in some refrigerant circuits in the automotive industry. However in such instances it has been proposed for use solely within the refrigerant circuit to pre-cool the liquid refrigerant leading to the evaporator using evaporated refrigerant on the discharge line from the evaporator. By contrast, the internal heat exchanger 300 is being used to cool the coolant in the battery circuit 60 upstream from the thermal load 96. As a result of providing the internal heat exchanger 300 one can eliminate the need to provide a chiller for cooling the battery circuit 60.

The internal heat exchanger 300 is relatively less efficient than a typical chiller, but is sufficient to cool the battery circuit thermal load 96. It is expected that it will take a longer period of time for the internal heat exchanger 300 to cool the battery circuit thermal load 96 by a selected number of degrees than it would take a chiller, however.

Several situations are discussed in relation to the control of the components of the refrigerant circuit 62. In a situation where the air conditioning in the vehicle 10 is already on (and therefore the compressor 30 is already on), and where the controller 78 determines that the temperature at temperature sensor 116 exceeds a selected threshold temperature, the controller 78 may increase the speed of the compressor 30 if possible. When the temperature at the temperature sensor 116 has been reduced to a desired temperature, the controller 78 may reduce the speed of the compressor 30 to whatever its speed was before the controller 78 increased it, unless the vehicle occupants have changed the air conditioning settings in the interim, in which case the controller 78 would adjust the speed of the compressor 30 in order to comply with the new air conditioning settings set by the occupants. It will be noted, however, that whenever the air conditioning system is operating, refrigerant is sent through the internal heat exchanger 300 and as a result some cooling of the battery circuit thermal load 96 takes place. There is a significant probability that when the vehicle 10 is hot enough that air conditioning is needed, the battery circuit thermal load 96 will creep up in temperature during operation of the vehicle 10. Cooling the battery circuit thermal load 96 even before the battery circuit thermal load 96 reaches the threshold temperature helps to slow down or even prevent the ramping up of the temperature of the battery circuit thermal load 96, which increases the amount of time the vehicle 10 can operate before needing to raise the speed of the compressor 30, which helps to save energy. Also, raising the speed of the compressor 30 would impact the air conditioning system, possibly cooling the passenger cabin 18 faster than is desired by the vehicle occupants. Any change to the air conditioning system that is not initiated by the vehicle occupants can lead to occupant discomfort. Accordingly it is beneficial for the vehicle to do so as infrequently as possible.

In a situation where the air conditioning in the vehicle 10 is off (and therefore the compressor 30 is off) and where the controller 78 determines that the temperature at temperature sensor 116 exceeds the selected threshold temperature, the controller 78 turns on the compressor 30 to initiate operation of the refrigerant circuit 62. In such a situation, there may be no air flow over the evaporator, however, since the air conditioning system is off. As a result, generating refrigerant flow through the refrigerant circuit 62 can lead to the freezing of the evaporator 48 if no steps are taken to prevent freezing of the evaporator 48. In order to inhibit this from occurring the speed of the compressor 30 may be reduced by the controller 78 to a low speed so that a reduced flow of refrigerant is provided. As a result of the speed reduction, there is less cooling that takes place in the evaporator 48, which helps to extend the amount of time that it would take for the evaporator 48 to freeze or possibly to prevent the freezing altogether. To further assist in inhibiting the evaporator 48 from freezing, the controller 78 may initiate operation of the air conditioning fan (shown at 137) at a relatively low speed so as to provide some airflow over the evaporator 48. This airflow would then enter the vehicle cabin 46 but would be at a relatively low flow rate so as not to overly cool the cabin 18 when the cabin occupants did not request such cooling. Once the temperature at the temperature sensor 116 has dropped to a selected temperature, the controller 78 may turn off the compressor 30, and may turn off the air conditioning fan 138 if there has been no request for air conditioning made by the vehicle occupants in the interim.

Instead of turning on the air conditioning fan 138 so as to prevent the evaporator from freezing, it is alternatively possible to provide an evaporator bypass conduit that bypasses the evaporator 48, and extends from a point on the first refrigerant conduit 126 to a point on the second refrigerant conduit 127. A three-way evaporator bypass valve could be provided would be positionable in a first position to permit refrigerant flow through the evaporator 48 and a second position to bypass the evaporator 48. In such an embodiment the refrigerant could be run through a dedicated thermal expansion valve upstream (and downstream) from the internal heat exchanger 300.

Eliminating the need for a chiller improves the reliability of the refrigerant circuit 62, and reduces the cost of the refrigerant circuit 62. Furthermore, the internal heat exchanger 300 has a lower pressure drop than a chiller might have, and thus energy is saved in terms of the energy required to convey refrigerant around the refrigerant circuit 62.

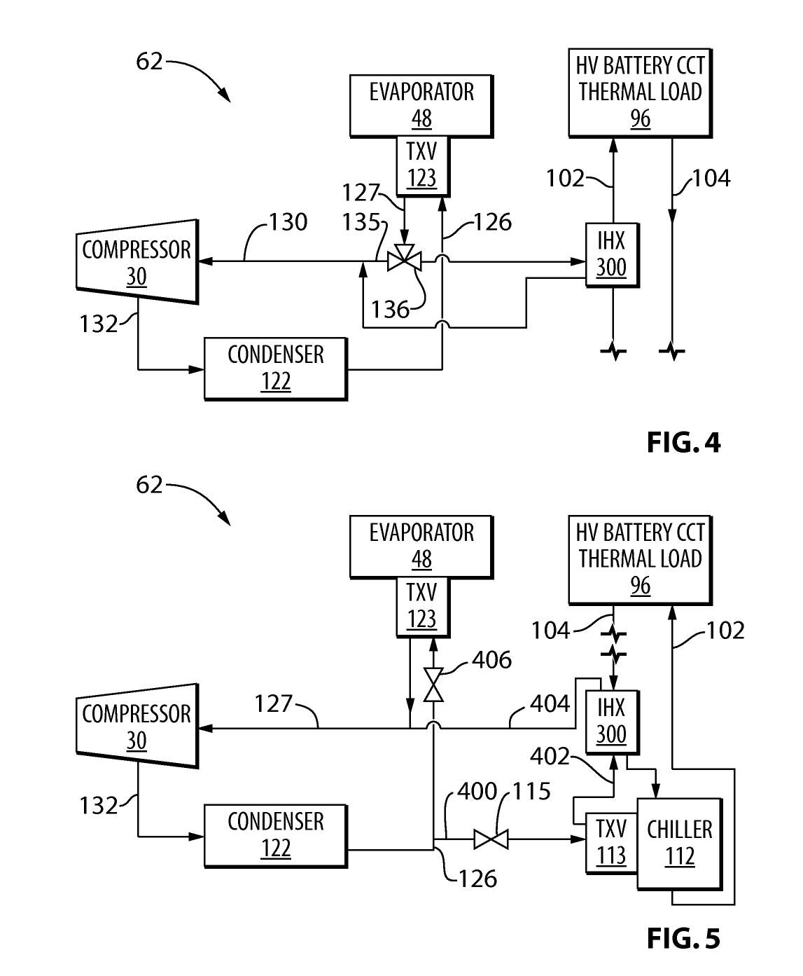

An alternative embodiment of the refrigerant circuit 62 is shown in FIG. 4. Only selected portions of the battery circuit 60 are shown in this figure. This embodiment may be similar to the embodiment shown in FIG. 2, except that a fifth refrigerant conduit 135, which may be referred to as an internal heat exchanger bypass conduit 135, extends between a point on the second refrigerant conduit 127 and a point on the third refrigerant conduit 130. A three-way internal heat exchanger bypass valve 136 is provided at the junction of the second and fifth refrigerant conduits 126 and 135 and is positionable in a first position to permit refrigerant flow through the internal heat exchanger 300, and a second position to bypass the internal heat exchanger 300.

The refrigerant circuit 62 shown in FIG. 4 has an advantage relative to the circuit 62 shown in FIG. 2, in that it is possible for the refrigerant leaving the evaporator 48 to be directed directly to the compressor 30 without having to go through the internal heat exchanger 300. Thus, in situations where the vehicle occupants turn on the air conditioner but where the battery circuit thermal load 96 is not ramping up in temperature, it is possible to bypass the internal heat exchanger 300 using the bypass valve 136, so as not to waste energy conveying fluid through the internal heat exchanger 300 when it is not especially advantageous.

In an embodiment shown in FIG. 5, the refrigerant circuit 62 includes a chiller 112, which is also used to cool coolant in the first battery circuit conduit 102, downstream from the internal heat exchanger 300. The chiller 112 receives refrigerant via a chiller inlet conduit 400, which extends to the chiller 112 from a point on the liquid conduit 126. A chiller discharge conduit 402 extends from the chiller 112 to the internal heat exchanger 300. An internal heat exchanger discharge conduit 404 extends from the internal heat exchanger to a point on the compressor suction conduit 127. The internal heat exchanger 300 pre-cools the coolant entering the chiller 112 so that the chiller 112 has less work to do to cool the coolant to a selected temperature. Upstream from the chiller 112 on the chiller inlet conduit 400 is a chiller thermal expansion valve 113, which controls the pressure of refrigerant entering chiller 112. Upstream from the thermal expansion valve 113 on the chiller inlet conduit 400 is a chiller bypass valve 115. It will also be seen that upstream from the thermal expansion valve 123 is an evaporator bypass valve 406. While this embodiment lacks the benefit of completely replacing the chiller as shown in FIGS. 2 and 4, it is still advantageous relative to systems of the prior art because the chiller 112 might be much smaller than a chiller that might be provided if there were no internal heat exchanger present, and additionally, the chiller may be used much less frequently than a refrigerant circuit with no internal heat exchanger.

Several situations are discussed in relation the embodiment shown in FIG. 5. In a situation where the air conditioning in the vehicle 10 is already on (and therefore the compressor 30 is already on) refrigerant is directed from the compressor 30, though the condenser 122, through the thermal expansion valve 123 and the evaporator 48 and back to the compressor 30. The evaporator bypass valve 406 is open so as to permit refrigerant flow through the evaporator 48, and the chiller bypass valve 402 may be closed assuming the temperature of the battery circuit thermal load 96 is initially relatively low. When the controller 78 determines that the temperature at temperature sensor 116 exceeds a selected threshold temperature, the controller 78 may increase the speed of the compressor 30 if possible and will open the chiller bypass valve 115 so that the refrigerant flow is split between the evaporator 48 and the chiller 112. Thus, some refrigerant flows through the thermal expansion valve 123, through the evaporator 48 and through the compressor suction conduit 126 to the compressor 30. Additionally, some refrigerant flows through the thermal expansion valve 113, through the chiller 112, through the chiller discharge conduit 402, through the internal heat exchanger 300, through the internal heat exchanger discharge conduit 404, and into the compressor suction conduit 126. Thus, the internal heat exchanger 300 uses some remaining heat absorption capability that remains in the refrigerant after being discharged from the chiller 112, to pre-cool coolant that is about to enter the chiller 112. Thus, providing the internal heat exchanger 300 will reduce the temperature of the coolant that enters the chiller 112 from the battery circuit thermal load 96 as compared to a system that did not have the internal heat exchanger 300. As a result, the chiller 112 in the circuit 62 need not be as large as the chiller 112 would have to be if there were no internal heat exchanger present. This reduction in size results in a reduction in the power draw associated with the chiller 112. This reduction in power draw comes at the cost of an added power draw associated with the internal heat exchanger 300, however, this added power draw is relatively small compared to the savings in power draw that can be achieved with a smaller chiller.

When the temperature at the temperature sensor 116 has been reduced to a desired temperature, the controller 78 may reduce the speed of the compressor 30 to whatever the speed of the compressor 30 was before the controller 78 increased the speed of the compressor 30, unless the vehicle occupants have changed the air conditioning settings in the interim, in which case the controller 78 would adjust the speed of the compressor 30 in order to comply with the new air conditioning settings set by the occupants. Additionally, the controller 78 would close the chiller bypass valve 115 so as to prevent refrigerant flow through the chiller 112 and through the internal heat exchanger 300.

In a situation where the air conditioning in the vehicle 10 is off (and therefore the compressor 30 is off), the evaporator bypass valve 406 may be closed or open, and the chiller bypass valve 115 may be closed presuming that the temperature of the battery circuit thermal load 96 is initially relatively low. When the controller 78 determines that the temperature at temperature sensor 116 exceeds the selected threshold temperature, the controller 78 turns on the compressor 30 to initiate operation of the refrigerant circuit 62 and ensures that the evaporator bypass valve 406 is closed. Once the temperature at the temperature sensor 116 has dropped to a selected temperature, the controller 78 may turn off the compressor 30, and may close the chiller bypass valve 115.

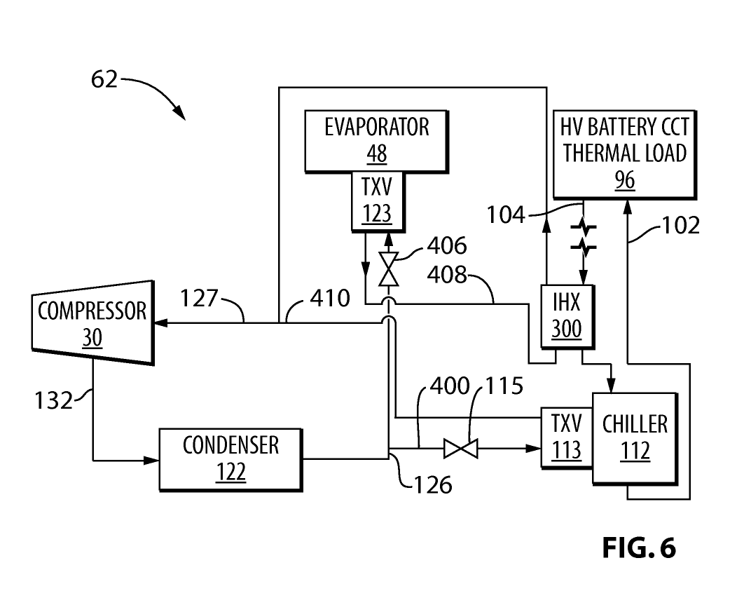

Reference is made to FIG. 6, which shows another embodiment of the refrigerant circuit 62. In the embodiment shown in FIG. 6, a chiller 112 and an internal heat exchanger 300 are provided, with the internal heat exchanger 300 precooling coolant that is about to enter the chiller 112, similarly to the circuit 62 shown in FIG. 5. However, the routing of the conduits is different in the embodiment shown in FIG. 6. In this embodiment, the evaporator 48 discharges refrigerant through an internal heat exchanger inlet conduit 408 (which may be referred to as an evaporator discharge conduit 408, the compressor suction conduit 127 extends from the internal heat exchanger 300 to the compressor 30, the chiller inlet conduit 400 is provided and extends to the thermal expansion valve 113 from the liquid conduit 126, and the chiller discharge conduit shown at 410 extends from the chiller 112 to the compressor suction conduit 126. The chiller bypass valve 115 is provided in the chiller inlet conduit 400 upstream from the thermal expansion valve 113.

Several situations are discussed in relation the embodiment shown in FIG. 6. In a situation where the air conditioning in the vehicle 10 is already on (and therefore the compressor 30 is already on) refrigerant is directed from the compressor 30, though the condenser 122, through the thermal expansion valve 123 and the evaporator 48, through the internal heat exchanger 300 and back to the compressor 30. The evaporator bypass valve 406 is open so as to permit refrigerant flow through the evaporator 48, and the chiller bypass valve 402 may be closed assuming the temperature of the battery circuit thermal load 96 is initially relatively low. Like the embodiment shown in FIG. 2, when the air conditioning system is turned on by the vehicle occupants, it is presumed that the battery circuit thermal load 96 is likely to be ramping up in temperature and would benefit from being cooled even though the temperature at sensor 116 has not yet exceeded the threshold temperature. Using the internal heat exchanger 300 whenever the air conditioning is on slows the ramping up of the temperature and therefore delays having to use the chiller 112 to cool the coolant in the battery circuit 62. The power draw associated with the chiller 112 may be significantly higher than the power draw associated with the internal heat exchanger 300. More specifically, the power draw associated with the chiller 112 may be in the range of 1 kW or more. The power draw associated with the internal heat exchanger 300 may be a few watts. Thus there is a net power savings if the use of the chiller 112 is delayed even if the internal heat exchanger 300 was being used for longer than the chiller 112 would need.

When the controller 78 determines that the temperature at temperature sensor 116 exceeds a selected threshold temperature, the controller 78 may increase the speed of the compressor 30 if possible and will open the chiller bypass valve 115 so that the refrigerant flow is split between the evaporator 48 and the chiller 112. Thus, the internal heat exchanger 300 precools coolant entering the chiller 112, using refrigerant discharged from the evaporator 48. Thus, providing the internal heat exchanger 300 will reduce the temperature of the coolant that enters the chiller 112 from the battery circuit thermal load 96 as compared to a system that did not have the internal heat exchanger 300. As a result, the chiller 112 in the circuit 62 need not be as large as the chiller 112 would have to be if there were no internal heat exchanger present. This reduction in size results in a reduction in the power draw associated with the chiller 112.

It can be seen that when the air conditioning system is on and the chiller 112 is subsequently called into use, the splitting of the refrigerant flow between the evaporator 48 and the chiller 112 will negatively impact the performance of the evaporator 48 in cooling the vehicle cabin 18, which can lead to occupant discomfort. Thus it is beneficial to delay or prevent the use of the chiller 112 where possible. By using the internal heat exchanger 300 to cool the coolant in the battery circuit 62 whenever the air conditioning system is on, the use of the chiller 112 may be delayed or even prevented.

When the temperature at the temperature sensor 116 has been reduced to a desired temperature, the controller 78 may reduce the speed of the compressor 30 to whatever the speed of the compressor 30 was before the controller 78 increased the speed of the compressor 30 as in the embodiments shown in the other figures, unless the vehicle occupants have changed the air conditioning settings in the interim, and the controller 78 would close the chiller bypass valve 115 so as to prevent refrigerant flow through the chiller 112.

In a situation where the air conditioning in the vehicle 10 is off (and therefore the compressor 30 is off), the evaporator bypass valve 406 may be closed or open, and the chiller bypass valve 115 may be closed presuming that the temperature of the battery circuit thermal load 96 is initially relatively low. When the controller 78 determines that the temperature at temperature sensor 116 exceeds the selected threshold temperature, the controller 78 turns on the compressor 30 to initiate operation of the refrigerant circuit 62, opens the chiller bypass valve 115, and will in some embodiments ensure that the evaporator bypass valve 406 is closed. Once the temperature at the temperature sensor 116 has dropped to a selected temperature, the controller 78 may turn off the compressor 30, and may close the chiller bypass valve 115.

A refrigerant pressure sensor 142 may be provided anywhere suitable in the refrigerant circuit 62, such as on the first conduit 126 upstream from the evaporator 48. The pressure sensor 142 communicates pressure information from the refrigerant circuit 62 to the controller 78.

A fan shown at 144 is provided for blowing air on the radiator 64 and the condenser 122 to assist in cooling and condensing the heat exchange fluid and the refrigerant respectively. The fan 144 is controlled by the controller 78.

An expansion tank 124 is provided for removing gas that can accumulate in other components such as the radiator 64. The expansion tank 124 may be positioned at the highest elevation of any fluid-carrying components of the thermal management system. The expansion tank 124 may be used as a point of entry for heat exchange fluid into the thermal management system 10 (i.e. the system 10 may be filled with the fluid via the expansion tank 124).

The controller 78 is described functionally as a single unit, however the controller 78 may be made up of a plurality of units that communicate with each other and which each control one or more components of the thermal management system 10, as well as other components optionally.

Throughout this disclosure, the controller 78 is referred to as turning on devices (e.g. the battery circuit heater 108, the chiller 112), turning off devices, or moving devices (e.g. valve 134) between a first position and a second position. It will be noted that, in some situations, the device will already be in the position or the state desired by the controller 78, and so the controller 78 will not have to actually carry out any action on the device. For example, it may occur that the controller 78 determines that the battery circuit heater 108 needs to be turned on. However, the heater 108 may at that moment already be on based on a prior decision by the controller 78. In such a scenario, the controller 78 obviously does not actually ‘turn on’ the heater 108, even though such language is used throughout this disclosure. For the purposes of this disclosure and claims, the concepts of turning on, turning off and moving devices from one position to another are intended to include situations wherein the device is already in the state or position desired and no actual action is carried out by the controller on the device.

In the figures, the cabin heating circuit 58, the battery circuit 60 and the motor circuit 56 are all shown as being integrated into a single large system with one radiator. It will be understood, however, that this is not necessary, and it is entirely possible for the battery circuit 60 to be separate and to have a dedicated radiator.

While the above description constitutes a plurality of example embodiments, it will be appreciated that these embodiments are examples only and are susceptible to further modification and change without departing from the fair meaning of the accompanying claims.

1. A thermal management system for an electric vehicle, the electric vehicle including a traction motor and at least one battery pack, comprising:
a radiator;
a battery circuit for controlling the temperature of a battery circuit thermal load which includes the at least one battery pack, wherein the battery circuit thermal load has a battery circuit thermal load inlet and a battery circuit thermal load outlet, wherein the battery circuit includes a plurality of battery circuit conduits fluidically between the radiator and the battery circuit thermal load;
a refrigerant circuit that includes an evaporator thermal expansion valve, an evaporator downstream from the evaporator thermal expansion valve, a condenser upstream from the evaporator, a compressor that is downstream from the evaporator and upstream from the condenser, and a plurality of refrigerant conduits fluidically connecting the evaporator, the condenser and the compressor together; and
an internal heat exchanger comprising an inner conduit and an outer conduit, wherein the inner conduit extends within the outer conduit,
wherein one of the inner and outer conduits is fluidically connected as part of the battery circuit, and wherein the other of the inner and outer conduits is fluidically connected as part of the refrigerant circuit.

2. A thermal management system as claimed in claim 1, wherein the internal heat exchanger is fluidically between the evaporator and the compressor.

3. A thermal management system as claimed in claim 1, wherein the refrigerant circuit includes a liquid conduit positioned between the condenser and the evaporator thermal expansion valve, an evaporator discharge conduit between the evaporator and the internal heat exchanger, a compressor suction conduit between the internal heat exchanger and the compressor, and a compressor discharge conduit between the compressor and the condenser, wherein refrigerant leaving the evaporator thermal expansion valve passes through the internal heat exchanger.

4. A thermal management system as claimed in claim 1, wherein the refrigerant circuit includes a liquid conduit positioned between the condenser and the evaporator thermal expansion valve, an internal heat exchanger inlet conduit between the evaporator and the internal heat exchanger, a compressor suction conduit between the internal heat exchanger and the compressor, a compressor discharge conduit between the compressor and the condenser, and an internal heat exchanger bypass conduit connected between the internal heat exchanger inlet conduit and the compressor suction conduit, and an internal heat exchanger bypass valve that is positionable in a first position to permit flow of refrigerant from the evaporator to the internal heat exchanger, and a second position to bypass the internal heat exchanger.

5. A thermal management system as claimed in claim 1, further comprising a chiller positioned to cool coolant in the battery circuit downstream from the internal heat exchanger, wherein the refrigerant circuit includes a liquid conduit positioned between the condenser and the thermal expansion valve, a chiller inlet conduit extending between the liquid conduit and the chiller for feeding refrigerant to the chiller, and a chiller thermal expansion valve upstream from the chiller in the chiller inlet conduit.

6. A thermal management system as claimed in claim 5, wherein the refrigerant circuit further includes a compressor suction conduit between the evaporator and the compressor, a chiller discharge conduit between the chiller and the internal heat exchanger, and an internal heat exchanger discharge conduit between the internal heat exchanger and the compressor suction conduit,
wherein the thermal management system further comprises an evaporator bypass valve positioned in the liquid conduit and downstream from the chiller inlet conduit, wherein the evaporator bypass valve is positionable in an open position to permit refrigerant flow into the evaporator, and a closed position to prevent refrigerant flow into the evaporator,
and wherein the thermal management system further comprises a chiller bypass valve positioned in the chiller inlet conduit, wherein the chiller bypass valve is positionable in an open position to permit refrigerant flow into the chiller, and a closed position to prevent refrigerant flow into the chiller.

7. A thermal management system as claimed in claim 5, wherein the refrigerant circuit further includes an evaporator discharge conduit positioned between the evaporator and the internal heat exchanger, a compressor suction conduit between the internal heat exchanger and the compressor, and a chiller discharge conduit between the chiller and the compressor suction conduit,
wherein the thermal management system further comprises an evaporator bypass valve positioned in the liquid conduit and downstream from the chiller inlet conduit, wherein the evaporator bypass valve is positionable in an open position to permit refrigerant flow into the evaporator, and a closed position to prevent refrigerant flow into the evaporator,
and wherein the thermal management system further comprises a chiller bypass valve positioned in the chiller inlet conduit, wherein the chiller bypass valve is positionable in an open position to permit refrigerant flow into the chiller, and a closed position to prevent refrigerant flow into the chiller.

8. A thermal management system as claimed in claim 7, wherein the compressor is operated to run refrigerant through the evaporator in order to cool the vehicle cabin upon a request for cool air in the vehicle cabin, wherein the evaporator discharges the refrigerant to the internal heat exchanger via the evaporator discharge conduit, so that the internal heat exchanger cools coolant in the battery circuit upon a request for cool air in the vehicle cabin.

9. A thermal management system as claimed in claim 3, wherein the compressor is powered by an electric motor, and wherein the thermal management system further comprises:
a cabin air flow conduit that directs air into a passenger cabin of the vehicle, wherein the cabin air flow conduit is arranged to transfer heat from air in the cabin air flow conduit to refrigerant in the evaporator;
a fan for controlling the flow of air in the cabin air flow conduit; and
a controller programmed to:
initiate operation of the compressor, the condenser and the evaporator based on the temperature of the battery circuit thermal load, and
ensure that the fan is operating at at least a selected speed when the operation of the compressor, the condenser and the evaporator has been initiated based on the temperature of the at least one battery pack.
